(19) United States
(12) Patent Application Publication
(10) Pub. No.: US 2020/0218531 A1
(43) Pub. Date: Jul. 9, 2020

(54) OVER-THE-AIR (OTA) UPDATES OF ELECTRONIC CONTROL UNITS (ECUs) IN VEHICLES

(71) Applicant: Nokia Solutions and Networks Oy, Espoo (FI)

(72) Inventors: Rakesh Kushwaha, Marlboro, NJ (US); Colin Grealish, Brighton (GB); Kedar Namjoshi, Basking Ridge, NJ (US); Guang Zeng, Lexington, MA (US); Nabil Bitar, Acton, MA (US)

(21) Appl. No.: 16/241,696

(22) Filed: Jan. 7, 2019

(51) Int. Cl. G06F 8/65; H04L 29/08; H04W 4/44

(52) U.S. Cl. CPC G06F 8/66; H04W 4/44; H04L 67/34

(57) ABSTRACT

Systems, methods, and software for performing Over-The-Air (OTA) updates on vehicles. In one embodiment, an OTA update manager stores updated software components for ECUs installed in vehicles, and authorized software configurations for the vehicles that are verified by a manufacturer. When an OTA connection is established with a vehicle, the OTA update manager identifies a software state of the ECUs in the vehicle, selects a set of updated software components for installation in the vehicle based on the software state and the authorized software configuration, generates an update plan for installing the set of updated software components that indicates an order for installing the set of the updated software components, and downloads the update plan to the vehicle via the OTA connection.

### TECHNICAL FIELD

This disclosure relates to the field of communication systems and, in particular, to software updates of electronic control units in vehicles.

### BACKGROUND

Modern vehicles are equipped with multiple Electronic Control Units (ECUs), such as hundreds or more, that control subsystems in the vehicle. For example, the ECUs may control subsystems for the engine (e.g., performance, fuel efficiency, emissions, etc.), the transmission, the brakes, the suspension, advanced safety and collision avoidance systems, door looks, climate-control systems, body systems, etc. Generally, an ECU is an embedded system that includes a microprocessor, memory (e.g., Random Access Memory (RAM), Programmable Read-Only Memory (PROM), flash, etc.), sensor inputs, and output drivers. On an ECU, specialized software (including firmware) is executed by the microprocessor to process signals received from sensors via the sensor inputs, and control various elements in the vehicle via the output drivers. The ECUs in the vehicle are typically connected via a bus, such as a Local Interconnect Network (LIN), Controller Area Network (CAN), Media-Oriented System Transport (MOST), Ethernet, etc.

Software updates for the ECUs may be scheduled from time to time to address recalls, feature upgrades, security patches, customer complaints, or other issues. Software updates were traditionally performed at a dealership where a shop computer was wired directly to an on-board diagnostics receptacle on the vehicle. Depending on the Original Equipment Manufacturers (OEM) year, make, model, engine, chassis, transmission, etc., there may be multiple updates to ECUs. Thus, it is desirable to make updates of ECUs as effective and efficient as possible.

### SUMMARY

Embodiments described herein are directed to automatic Over-The-Air (OTA) updates of ECUs. An OTA update refers to the process of transferring updated software components to a vehicle using wireless connectivity, and transferring a plan for installing the updated software components to update the software on one or more of the ECUs on the vehicle. When a vehicle connects with a wireless network, an OTA update manager identifies updated software components for the vehicle, and formulates a plan for installing the updated software components on the vehicle. The plan indicates an order for installing the updated software components, which is formulated based on constraints provided by the vehicle manufacturer. The OTA update manager then sends the plan to the vehicle via wireless signals, and one or more central gateways on the vehicle install the updated software components on the ECUs based on the plan. OTA updates improve lifecycle management of the software components on vehicles as the updates may be performed at any location where the vehicle has access to a wireless network. Thus, an owner does not need to take the vehicle to a dealership to update the ECUs.

One embodiment comprises an OTA update manager comprising data storage configured to store updated software components for ECUs installed in vehicles, and to store authorized software configurations for the vehicles that are verified by a manufacturer. The OTA update manager further comprises first circuitry configured to establish an OTA connection with a first one of the vehicles for a first OTA update. OTA update manager further comprises second circuitry, responsive to the first one of the vehicles connecting with the first circuitry, configured to identify a first software state of the ECUs in the first one of the vehicles, to select a first set of the updated software components for installation in the first one of the vehicles based on the first software state and a first one of the authorized software configurations for the first one of the vehicles, and to generate a first update plan for installing the first set of the updated software components based on the first software state and the first one of the authorized software configurations. The first update plan indicates an order for installing the first set of the updated software components in the first one of the vehicles. The first circuitry is further configured to download the first update plan to the first one of the vehicles via the OTA connection for the first OTA update.

In another embodiment, the first circuitry is further configured to download the first set of the updated software components to the first one of the vehicles via the OTA connection for the first OTA update along with the first update plan as part of an update package.

In another embodiment, the first circuitry is further configured to download each updated software component of the first set separately over the OTA connection in response to a request from the first one of the vehicles.

In another embodiment, the first circuitry is configured to establish the OTA connection over a cellular network.

In another embodiment, the first circuitry is configured to establish the OTA connection over a Wireless Local Area Network (WLAN).

In another embodiment, the second circuitry is further configured to identify a request for a second OTA update for a fleet of the vehicles, to identify a second software state of the ECUs in the vehicles of the fleet, to select a second set of the updated software components for installation in the vehicles of the fleet based on the second software state and a second one of the authorized software configurations for the vehicles of the fleet, and to generate a second update plan for installing the second set of the updated software components based on the second software state and the second one of the authorized software configurations. The second update plan indicates an order for installing the second set of the updated software components in the vehicles of the fleet. The first circuitry is configured to push the second update plan to the vehicles of the fleet via OTA connections.

In another embodiment, the data storage is configured to provide a user interface that allows a supplier to upload the updated software components.

Another embodiment comprises a method of performing OTA updates for vehicles. The method comprises storing updated software components for ECUs installed in the vehicles, and storing authorized software configurations for the vehicles that are verified by a manufacturer. The method further comprises establishing an OTA connection with a first one of the vehicles for a first OTA update. Responsive to the first one of the vehicles connecting via the OTA connection, the method comprises identifying a first software state of the ECUs in the first one of the vehicles, selecting a first set of the updated software components for installation in the first one of the vehicles based on the first software state and a first one of the authorized software configurations for the first one of the vehicles, and generating a first update plan for installing the first set of the updated software components based on the first software state and the first one of the authorized software configurations. The first update plan indicates an order for installing the first set of the updated software components in the first one of the vehicles. The method further comprises downloading the first update plan to the first one of the vehicles via the OTA connection for the first OTA update.

In another embodiment, the method further comprises downloading the first set of the updated software components to the first one of the vehicles via the OTA connection for the first OTA update along with the first update plan as part of an update package.

In another embodiment, the method further comprises downloading each updated software component of the first set separately over the OTA connection in response to a request from the first one of the vehicles.

In another embodiment, establishing the OTA connection comprises establishing the OTA connection over a cellular network.

In another embodiment, establishing the OTA connection comprises establishing the OTA connection over a Wireless Local Area Network (WLAN).

In another embodiment, the method further comprises identifying a request for a second OTA update for a fleet of the vehicles, identifying a second software state of the ECUs in the vehicles of the fleet, selecting a second set of the updated software components for installation in the vehicles of the fleet based on the second software state and a second one of the authorized software configurations for the vehicles of the fleet, and generating a second update plan for installing the second set of the updated software components based on the second software state and the second one of the authorized software configurations. The second update plan indicates an order for installing the second set of the updated software components in the vehicles of the fleet. The method further comprises pushing the second update plan to the vehicles of the fleet via OTA connections.

In another embodiment, the method further comprises providing a user interface that allows a supplier to upload the updated software components.

Another embodiment comprises a system for performing OTA updates for vehicles. The system comprises a means for storing updated software components for ECUs installed in the vehicles, and a means for storing authorized software configurations for the vehicles that are verified by a manufacturer. The system further comprises a means for establishing an OTA connection with a first one of the vehicles for a first OTA update. The system, responsive to the first one of the vehicles connecting via the OTA connection, further comprises a means for identifying a first software state of the ECUs in the first one of the vehicles, a means for selecting a first set of the updated software components for installation in the first one of the vehicles based on the first software state and a first one of the authorized software configurations for the first one of the vehicles, and a means for generating a first update plan for installing the first set of the updated software components based on the first software state and the first one of the authorized software configurations. The first update plan indicates an order for installing the first set of the updated software components in the first one of the vehicles. The system further comprises a means for downloading the first update plan to the first one of the vehicles via the OTA connection for the first OTA update.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a communication system for OTA updates in an illustrative embodiment.

FIG. 2 is a block diagram of a network architecture of a vehicle in an illustrative embodiment.

FIG. 3 is a block diagram of an ECU.

FIG. 4 is a block diagram of an OTA update manager in an illustrative embodiment.

FIGS. 5-6 are flow charts illustrating a method of performing OTA updates in an illustrative embodiment.

FIG. 7 illustrates an OTA update in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

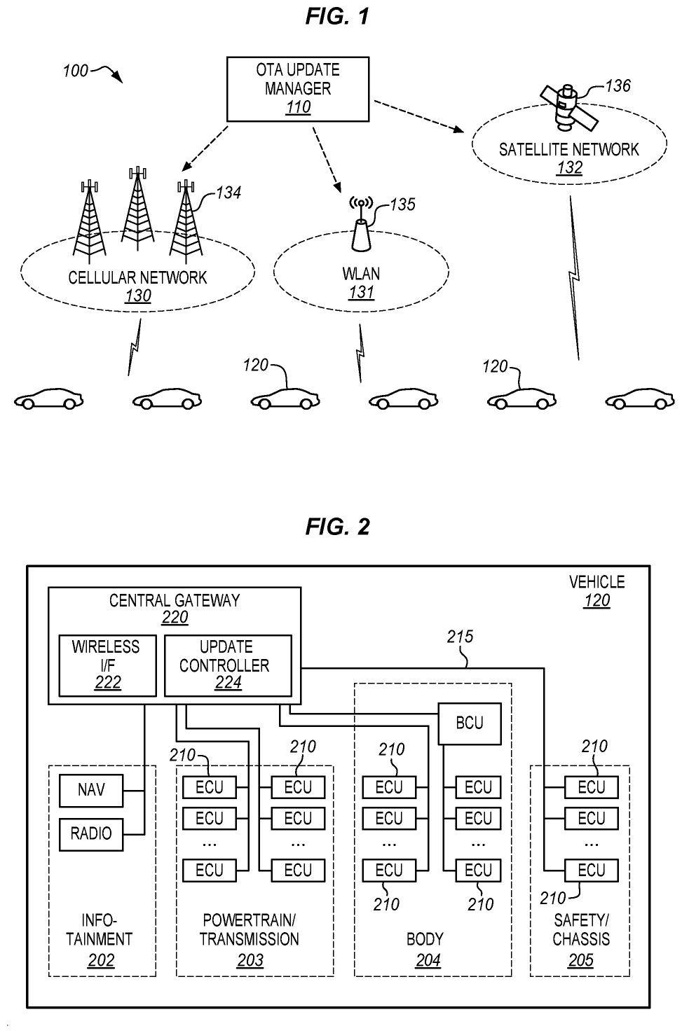

FIG. 1 illustrates a communication system 100 for OTA updates in an illustrative embodiment. Communication system 100 includes an OTA update manager 110, which comprises a system, circuitry, hardware (e.g., a processor or processors), etc., configured to orchestrate OTA updates for vehicles 120. OTA update manager 110 is configured to interface with vehicles 120 through wireless signals (also referred to as OTA signals). Therefore, OTA update manager 110 is communicatively coupled to one or more wireless networks, which utilize wireless technologies to transmit and receive data over the airwaves. For example, one or more of the wireless networks may be terrestrial networks, such as a cellular network 130 and/or a Wireless Local Area Network (WLAN) 131 (e.g., a Wi-Fi network). Cellular network 130 operates on Radio Frequency (RF) bands in the licensed spectrum through cell towers 134. Cellular network 130 may represent a next generation network (e.g., a 5G network), a Long-Term Evolution (LTE) network or another 4G network, etc. WLAN 131 operates on the unlicensed spectrum (e.g., 5 GHz band) through one or more access points 135. Another of the wireless networks may be a satellite network 132 that uses one or more communication satellites 136 for communication. Vehicles 120 may represent different types of vehicles, or may represent a fleet of vehicles of a common type.

FIG. 2 is a block diagram of a network architecture of a vehicle 120 in an illustrative embodiment. Vehicle 120 comprises a type of machine used for transportation, such as a motor vehicle (e.g., motorcycle, car, truck, bus, etc.), a railed vehicle (e.g., train), a watercraft (e.g., ship or boat), an aircraft, etc. Vehicle 120 may be the type that is manually driven, or may be an autonomous vehicle. The network architecture of vehicle 120 is made up of multiple ECUs, and each is configured to control a subsystem within the vehicle 120. In this example, the network architecture of vehicle 120 includes an InfoTainment domain 202, a powertrain and transmission domain 203, a body domain 204, and a safety/chassis domain 205. Each of the domains may have multiple ECUs 210. The network architecture further includes one or more central gateways 220. A central gateway 220 and ECUs 210 are interconnected using a specific type of a network interface or network bus 215, such as a Controller Area Network (CAN), Local Interconnect Network (LIN), FlexRay, etc. Central gateway 220 is configured to install software components on the ECUs 210. More particularly, central gateway 220 is configured to receive an OTA update from OTA update manager 110 (see FIG. 1), and install updated software components on the ECUs 210 based on instructions from OTA update manager 110. One or more of the ECUs 210 may have its own wireless connection, and can control or manage an OTA update from OTA update manager 110.

In this embodiment, central gateway 220 includes a wireless interface (I/F) 222 and an update controller 224. Wireless interface 222 comprises circuitry, logic, hardware, software, means, etc., configured to transmit and receive data via wireless signals. Wireless interface 222 may include one or more transceivers (radio, satellite, etc.) and one or more antennas that enable wireless communication on the licensed spectrum, the unlicensed spectrum, or the satellite spectrum. Update controller 224 represents circuitry, logic, hardware, software, means, etc., configured to control updates of software components on ECUs 210.

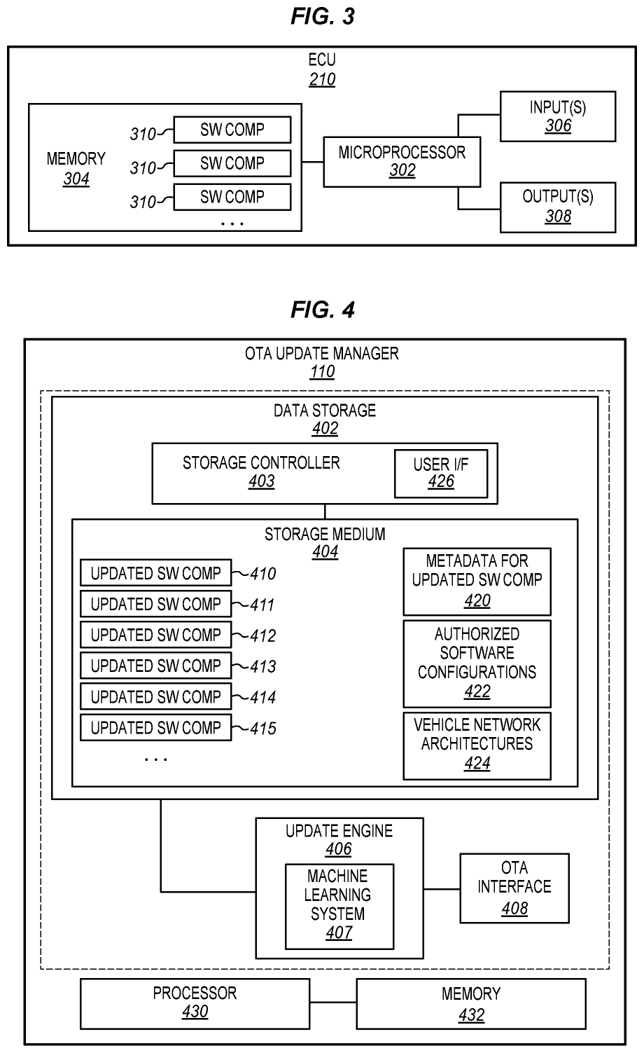

FIG. 3 is a block diagram of an ECU 210. ECU 210 is a device responsible for overseeing, regulating, and altering the operation of electronic subsystems in a vehicle 120. The term “ECU” as used herein may refer one or more of an Engine Control Module (ECM), a Powertrain Control Module (PCM), a Transmission Control Module (TCM), a Brake Control Module (BCM or EBCM), a Central Control Module (CCM), a Central Timing Module (CTM), a General Electronic Module (GEM), a Body Control Module (BCM), a Suspension Control Module (SCM), or another type of control unit. Generally, ECU 210 includes a microprocessor 302, a memory 304, one or more sensor inputs 306, and one or more output drivers 308. One or more software components 310 are installed in ECU 210, and stored in memory. A software component 310 (also referred to as a software part) is a software or firmware program or code for an ECU of a vehicle. Software components 310 are executed by microprocessor 302 to process signals received via sensor input 306, and control a subsystem in the vehicle 120 via output driver 308. Software components 310 that are presently installed in a vehicle 120 are referred to herein as installed software components.

FIG. 4 is a block diagram of OTA update manager 110 in an illustrative embodiment. As described above, OTA update manager 110 is a vehicle lifecycle management tool configured to orchestrate OTA updates for vehicles 120. OTA update manager 110 may be owned or operated by a vehicle manufacturer to provide the software updates, or may be owned or operated by a third-party provider.

In this embodiment, OTA update manager 110 includes the following subsystems: data storage 402, an update engine 406, and an OTA interface 408. Data storage 402 is a platform configured to maintain a collection of data. Data storage 402 may represent cloud storage, one or more databases, or other dedicated or shared data stores. In this embodiment, data storage 402 includes a storage controller 403 and storage medium 404. Storage medium 404 comprises circuitry, hardware, or other physical media configured to store data or information. Storage controller 403 comprises circuitry, hardware, or a means configured to control how data is stored on/in storage medium 404. Data storage 402 may be a repository for a variety of data related to OTA updates for vehicles 120. For example, data storage 402 is configured to store updated software components 410-415 for vehicles 120. An updated software component 410-415 (also referred to as an updated software part) is an updated software or firmware program or code for an ECU of a vehicle. Although not shown in FIG. 4, data storage 402 may also store older software components having prior or older versions of software or firmware programs. Data storage 402 is also configured to store metadata 420 for updated software components 410-415. For example, the metadata 420 may indicate a part number for an updated software component 410-415, a software version for an updated software component 410-415, or other information. Data storage 402 is also configured to store authorized software configurations 422 for vehicles that are tested and/or verified by the vehicle manufacturer(s) (i.e., Original Equipment Manufacturer (OEM)). As software components for ECUs are created and/or updated by the same or different vendors/suppliers, there may be issues of compatibility of the software components. Thus, the OEM tests or validates which versions of the software components are interoperable in the network architecture of a vehicle, and approves the versions for the release. For example, an OEM may determine via testing that version “1.1” of updated software component 410 in ECU X is interoperable with version “1.1” of software component B in ECU X and version “1.1” of software component C in ECU Y, but is not interoperable with version “1.0” of software component B in ECU X. Authorized software configurations 422 are therefore predetermined by the OEM before updated software components 410-415 are permitted for installation in vehicles. Data storage 402 may also be configured to store network architectures 424 for one or more types of vehicles. The network architecture 424 indicates the ECUs 210 installed in a vehicle, the software component(s) 310 in the ECUs 210, etc. Storage controller 403 may provide a user interface 426 or portal that allows OEMs, part suppliers or vendors, or other authorized entities to upload software components and other software-related data to data storage 402.

Update engine 406 comprises circuitry, logic, hardware, application server(s), means, etc., configured to generate an update plan for updating software in a vehicle or a fleet of vehicles. In generating the update plan, update engine 406 selects updated software components 410-415 for installation in a vehicle or fleet of vehicles, and determines an order or sequence for installing the updated software components 410-415 in the vehicle or fleet. Update engine 406 may use a variety of analysis tools in generating the update plans. For instance, update engine 406 may utilize machine learning or artificial intelligence (AI) techniques to generate the update plans, such as with machine learning system 407. Machine learning system 407 may be trained (using machine learning techniques) with the prior software updates on vehicles, and/or with other contextual information to develop a model for machine learning system 407. Based on this training, machine learning system 407 is able to generate an update plan for a vehicle or fleet.

OTA interface 408 comprises circuitry, logic, hardware, means, etc., configured to download or deploy the update plan to a vehicle or fleet as part of an OTA update. OTA interface 408 is a distribution platform for OTA updates, which includes the update plan and the updated software components 410-415. OTA interface 408 may packetize or otherwise format the update plan, and send the update plan to the vehicle or fleet over a wireless network.

One or more of the subsystems of OTA update manager 110 may be implemented on a hardware platform comprised of analog and/or digital circuitry. One or more of the subsystems of OTA update manager 110 may be implemented on a processor 430 that executes instructions stored in memory 432. Processor 430 comprises an integrated hardware circuit configured to execute instructions, and memory 432 is a computer readable storage medium for data, instructions, applications, etc., and is accessible by processor 430.

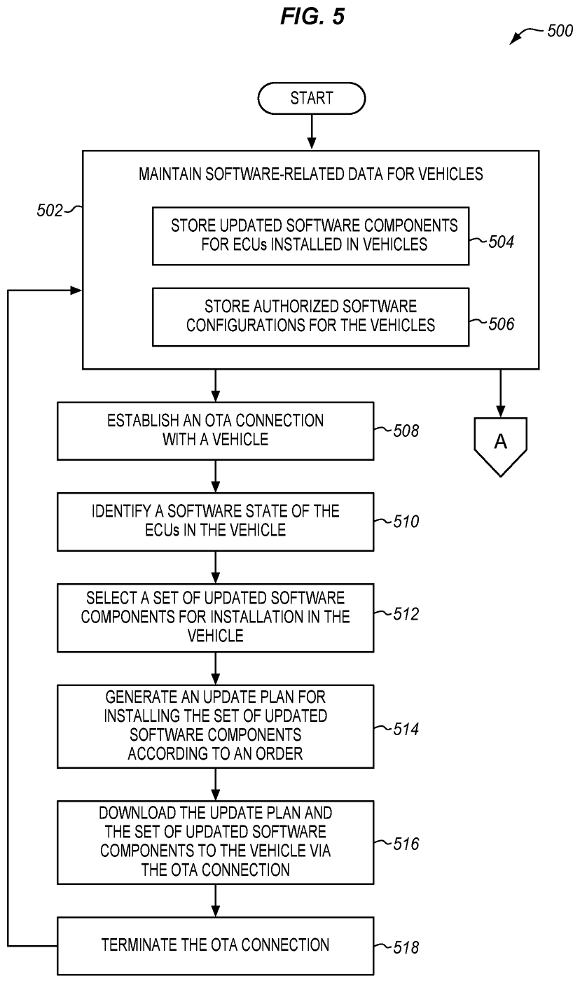

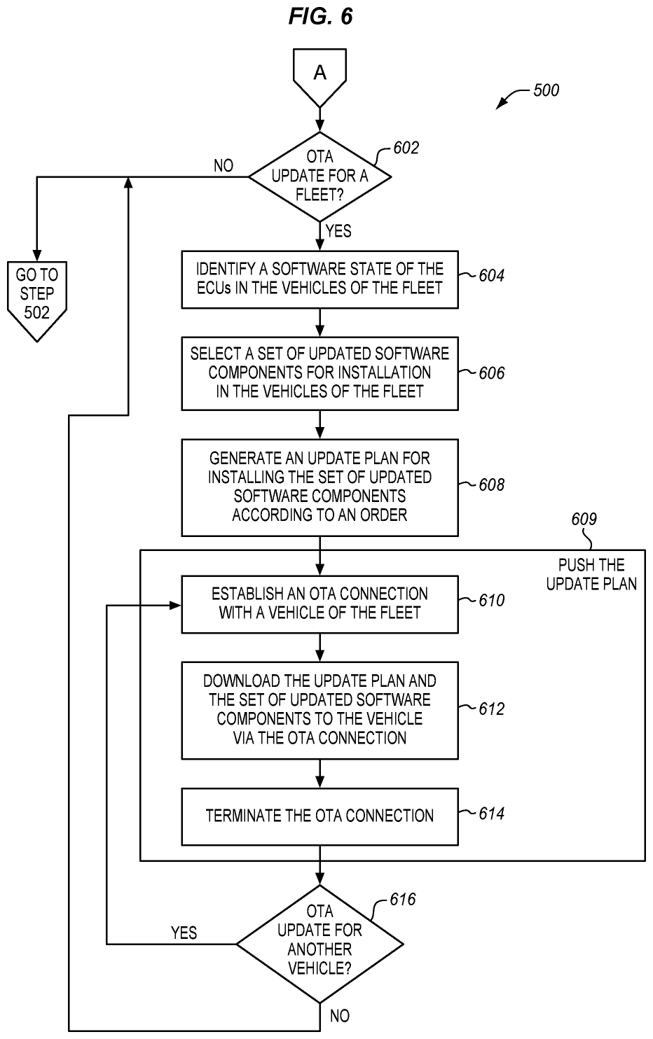

FIGS. 5-6 are flow charts illustrating a method 500 of performing OTA updates in an illustrative embodiment. The steps of method 500 will be described with reference to OTA update manager 110 in FIG. 4, but those skilled in the art will appreciate that method 500 may be performed in other systems. Also, the steps of the flow charts described herein are not all inclusive and may include other steps not shown, and the steps may be performed in an alternative order.

In FIG. 5, data storage 402 (see FIG. 4) is a repository for a variety of data used for OTA updates. Thus, data storage 402 maintains software-related data for vehicles 120 (step 502). The software-related data may be indexed based on metadata for the vehicles 120, such as make, model, model year, body style, trim level, etc. Storage controller 403 of data storage 402 may provide a user interface 426 or portal where OEMs, part suppliers or vendors, or other authorized entities may upload software-related data to data storage 402. That way, data storage 402 is supplied with current software-related data for vehicles 120. In particular, data storage 402 stores updated software components 410-415 for ECUs 210 installed in vehicles 120 (step 504), and stores authorized software configurations 422 for vehicles 120 that are verified by a manufacturer (step 506). The software-related data maintained by data storage 402 is used by update engine 406 to perform software updates on vehicles 120.

In one embodiment, an OTA update is performed when a vehicle 120 connects with OTA update manager 110. For a vehicle 120 to connect, OTA interface 408 establishes an OTA connection with the vehicle 120 (step 508). The OTA connection is a bidirectional communication between OTA interface 408 and a vehicle 120, where the last communication link is wireless. The OTA connection may use a variety of protocols, and each of the protocols may use authentication and security features to ensure a secure communication channel between OTA interface 408 and the vehicle 120. The OTA connection may be requested by the vehicle 120, or may be requested by OTA update manager 110. With an OTA connection established, vehicle 120 may be considered a “connected vehicle” and may upload data to OTA update manager 110, such as a Vehicle Identification Number (VIN), its software state, or other information.

After or responsive to the vehicle 120 connecting with OTA interface 408, update engine 406 identifies the software state of the ECUs 210 in the vehicle 120 (step 510). The software state indicates the software components presently installed on a vehicle 120. For example, the software state may indicate part numbers for the software components presently installed on a vehicle 120, software versions of the software components, a network architecture of the vehicle 120, and/or other information. Update engine 406 may receive the software state from the vehicle 120 via the OTA connection, or may retrieve the software state from another source, such as data storage 402.

For the OTA update, update engine 406 selects a set (i.e., a grouping of two or more) of updated software components 410-415 for installation in the vehicle 120 (step 512), and generates an update plan for installing the set of updated software components 410-415 in the vehicle 120 (step 514) based on the software state of the vehicle 120 and the authorized software configuration 422 for the vehicle 120. The update plan comprises instructions or commands for installing the set of updated software components 410-415 in the vehicle 120. The update plan at least indicates an order or sequence for installing the set of updated software components 410-415 in the vehicle 120. For example, update engine 406 may select updated software components 410, 411, and 413 for installation in the vehicle 120, and may determine that the updated software components should be installed in the following order, 411→413→410. Based on the software state of the ECUs 210 in the vehicle 120, update engine 406 is able to identify updated software components 410-415 that are available for the vehicle, and select two or more of the updated software components 410-415 for installation. The authorized software configuration 422 for the vehicle 120 indicates which software components are compatible with one another based on testing performed by the manufacturer. For example, an updated software component 410-415 may be compatible with the newest version of another software component, but not with an older version of the software component. Thus, authorized software configuration 422 puts constraints on how software components are installed in vehicles 120. Update engine 406 considers the updated software component 410-415 available for the vehicle 120 and the constraints (i.e., authorized software configuration 422) imposed by the manufacturer to select which of the updated software components 410-415 are to be installed and in what order. The update plan may also include instructions for removing prior software components, when to download the updated software components 410-415, or other instructions. The update plan may be optimized to minimize the cost of the software update (e.g., the fewest number of operations).

OTA interface 408 downloads the update plan to the vehicle 120 via the OTA connection for the OTA update (step 516). OTA interface 408 may also download the set of updated software components 410-415 to the vehicle 120 along with the update plan as part of an update package. Alternatively, OTA interface 408 may download each of the updated software components separately over the OTA connection in response to a request from the vehicle 120. Looking at FIG. 2, central gateway 220 in the vehicle 120 receives the update plan through wireless interface 222. Update controller 224 then processes the update plan to install the software update. For example, update controller 224 processes the update plan to determine an order for removing an old version of a software component, and replacing it with an updated software component 410-415. After providing the update plan and the set of updated software components 410-415 to the vehicle, the OTA connection may be terminated (step 518) and the OTA update is completed for this vehicle 120.

The OTA update process described above provides benefits in that software may be updated in vehicles wherever a wireless signal is available to the vehicle, and the vehicle does not need to be taken to a dealership for the updates. Thus, OTA updates may be used to install new features and fix faults at virtually any location. Not only is this convenient for the owner, but important features and fixes may be installed to improve safety, comfort, performance, etc.

FIG. 6 illustrates another embodiment for performing OTA updates for a fleet of vehicles. In FIG. 6, data storage 402 determines whether an OTA update has been requested for a fleet of vehicles 120 (step 602). An OTA update for a fleet may be requested by the OEM, by the owner of the fleet, in response to a particular updated software component 410-415 being uploaded to data storage 402, or may be requested in another way. If an OTA update has not been requested, then method 500 returns to step 502 in FIG. 5. When an OTA update has been requested, update engine 406 identifies the software state of the ECUs 210 in the vehicles 120 of the fleet (step 604). The software state of the vehicles 120 of the fleet may be stored in data storage 402. Update engine 406 selects a set (i.e., a grouping of two or more) of updated software components 410-415 for installation in the vehicles of the fleet (step 606), and generates a fleet update plan for installing the set of updated software components 410-415 in the vehicles 120 of the fleet (step 608) based on the software state of the vehicles 120 and the authorized software configuration 422 for the vehicles 120. Like above, the fleet update plan comprises instructions or commands for installing the set of updated software components 410-415 in the vehicles 120 of the fleet. The fleet update plan at least includes an order or sequence for installing the set of updated software components 410-415 in the vehicles 120 of the fleet.

With the fleet update plan generated for the vehicles 120 of the fleet, OTA interface 408 pushes the fleet update plan to the vehicles of the fleet via OTA connections (step 609). For instance, OTA interface 408 establishes an OTA connection with a vehicle 120 of the fleet (step 610), and downloads the fleet update plan to the vehicle 120 via the OTA connection for the OTA update (step 612). OTA interface 408 may also download the set of updated software components 410-415 to the vehicle 120 along with the fleet update plan as part of an update package. Alternatively, OTA interface 408 may download each of the updated software components separately over the OTA connection in response to a request from the vehicle 120. After providing the fleet update plan and the set of updated software component 410-415 to the vehicle 120, the OTA connection may be terminated (step 614).

If the OTA update is to be performed in other vehicles 120 of the fleet (step 616), then steps 610-614 repeat to download the fleet update plan to each of the vehicles 120 of the fleet. It is noted that OTA interface 408 may provide the OTA updates to multiple vehicles 120 of the fleet simultaneously.

### EXAMPLE

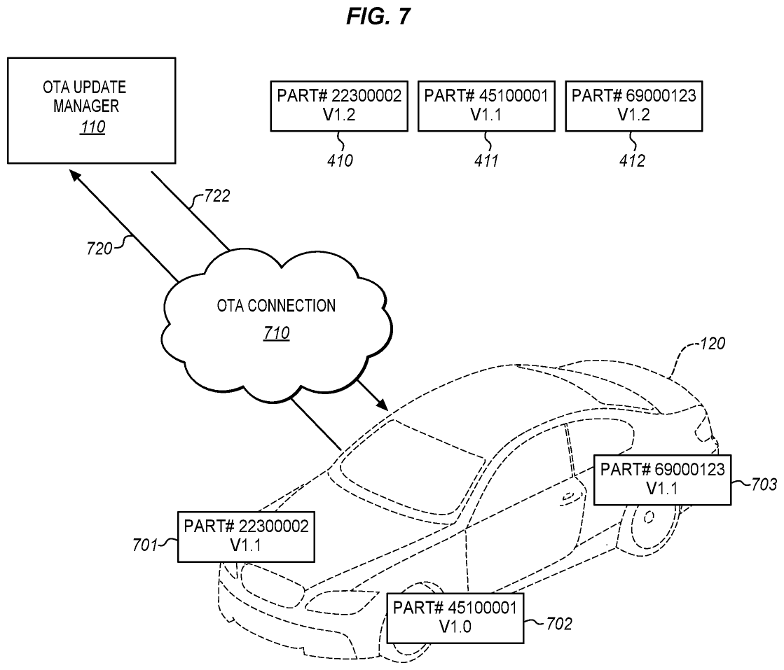

FIG. 7 illustrates an OTA update in an illustrative embodiment. FIG. 7 shows a vehicle 120 with three software components 701-703, although vehicle 120 may have several more software components that are not shown for the sake of brevity. Software components 701-703 are installed in ECUs (not shown) that control subsystems in vehicle 120. The metadata for software component 701 indicates a part number of “22300002” and a version of “1.1”, the metadata for software component 702 indicates a part number of “45100001” and a version of “1.0”, and the metadata for software component 703 indicates a part number of “69000123” and a version of “1.1”. To update the software on vehicle 120, OTA update manager 110 (through OTA interface 408) establishes an OTA connection 710 with the vehicle 120. With OTA connection 710 established, vehicle 120 is considered a “connected vehicle” and is able to upload its software state 720 to OTA update manager 110 over a secure channel. The software state 720 indicates software components 701-703 and the metadata associated with software components 701-703.

OTA update manager 110 (through data storage 402) stores updated software components 410-415 for ECUs installed in vehicle 120, and stores an authorized software configuration 422 for vehicle 120 that is verified by a manufacturer (see also, FIG. 4). Responsive to the vehicle 120 connecting via the OTA connection 710, OTA update manager 110 selects a set of updated software components 410-412 for installation in the vehicle 120, and generates an update plan for installing the set of updated software components 410-412 in the vehicle 120 based on the software state of the vehicle 120 and the authorized software configuration 422 for the vehicle 120. Assume, for this example, that an updated software component 410-412 is selected for each of software components 701-703 that are presently installed in the vehicle 120. Further assume that the metadata for updated software component 410 indicates a part number of “22300002” and a version of “1.2”, the metadata for updated software component 411 indicates a part number of “45100001” and a version of “1.1”, and the metadata for updated software component 412 indicates a part number of “69000123” and a version of “1.2”. In such a case, the update plan may comprise a series of instructions as follows:

(remove software component 702, part number 45100001, V1.0)

(download updated software component 411, part number 45100001, V1.1)

(install updated software component 411, part number 45100001, V1.1)

(remove software component 701, part number 22300002, V1.1)

(remove software component 703, part number 69000123, V1.1)

(download updated software component 410, part number 22300002, V1.2)

(download updated software component 412, part number 69000123, V1.2)

(install updated software component 410, part number 22300002, V1.2)

(install updated software component 412, part number 69000123, V1.2)

For the OTA update, OTA update manager 110 sends the update plan 722 to the vehicle 120 via the OTA connection 710 over a secure channel. Central gateway 220 in the vehicle 120 receives the update plan, and verifies that the update plan is authentic. Central gateway 220 then processes the update plan to update the software components in the vehicle 120, which may include removing an old software component, downloading an updated software component, and installing the updated software component.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:

(a) hardware-only circuit implementations (such as implementations in only analog and/or digital circuitry);

(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof.

1. An Over-The-Air (OTA) update manager, comprising:
data storage configured to store updated software components for Electronic Control Units (ECUs) installed in vehicles, and to store authorized software configurations for the vehicles that are verified by a manufacturer;
first circuitry configured to establish an OTA connection with a first one of the vehicles for a first OTA update; and
second circuitry, responsive to the first one of the vehicles connecting with the first circuitry, configured to identify a first software state of the ECUs in the first one of the vehicles, to select a first set of the updated software components for installation in the first one of the vehicles based on the first software state and a first one of the authorized software configurations for the first one of the vehicles, and to generate a first update plan for installing the first set of the updated software components based on the first software state and the first one of the authorized software configurations, wherein the first update plan indicates an order for installing the first set of the updated software components in the first one of the vehicles;
the first circuitry is further configured to download the first update plan to the first one of the vehicles via the OTA connection for the first OTA update.

2. The OTA update manager of claim 1, wherein:
the first circuitry is further configured to download the first set of the updated software components to the first one of the vehicles via the OTA connection for the first OTA update along with the first update plan as part of an update package.

3. The OTA update manager of claim 1, wherein:
the first circuitry is further configured to download each updated software component of the first set separately over the OTA connection in response to a request from the first one of the vehicles.

4. The OTA update manager of claim 1, wherein:
the first circuitry is configured to establish the OTA connection over a cellular network.

5. The OTA update manager of claim 1, wherein:
the first circuitry is configured to establish the OTA connection over a Wireless Local Area Network (WLAN).

6. The OTA update manager of claim 1, wherein:
the second circuitry is further configured to identify a request for a second OTA update for a fleet of the vehicles, to identify a second software state of the ECUs in the vehicles of the fleet, to select a second set of the updated software components for installation in the vehicles of the fleet based on the second software state and a second one of the authorized software configurations for the vehicles of the fleet, and to generate a second update plan for installing the second set of the updated software components based on the second software state and the second one of the authorized software configurations, wherein the second update plan indicates an order for installing the second set of the updated software components in the vehicles of the fleet; and
the first circuitry is configured to push the second update plan to the vehicles of the fleet via OTA connections.

7. The OTA update manager of claim 1, wherein:
the data storage is configured to provide a user interface that allows a supplier to upload the updated software components.

8. A method of performing Over-The-Air (OTA) updates for vehicles, the method comprising:
storing, at an OTA update manager, updated software components for Electronic Control Units (ECUs) installed in the vehicles;
storing, at the OTA update manager, authorized software configurations for the vehicles that are verified by a manufacturer;
establishing an OTA connection between the OTA update manager and a first one of the vehicles for a first OTA update; and
responsive to the first one of the vehicles connecting with the OTA update manager:
identifying a first software state of the ECUs in the first one of the vehicles;
selecting a first set of the updated software components for installation in the first one of the vehicles based on the first software state and a first one of the authorized software configurations for the first one of the vehicles;
generating a first update plan for installing the first set of the updated software components based on the first software state and the first one of the authorized software configurations, wherein the first update plan indicates an order for installing the first set of the updated software components in the first one of the vehicles; and
downloading the first update plan to the first one of the vehicles via the OTA connection for the first OTA update.

9. The method of claim 8, further comprising:
downloading the first set of the updated software components to the first one of the vehicles via the OTA connection for the first OTA update along with the first update plan as part of an update package.

10. The method of claim 8, further comprising:
downloading each updated software component of the first set separately over the OTA connection in response to a request from the first one of the vehicles.

11. The method of claim 8, wherein establishing the OTA connection comprises:
establishing the OTA connection over a cellular network.

12. The method of claim 8, wherein establishing the OTA connection comprises:
establishing the OTA connection over a Wireless Local Area Network (WLAN).

13. The method of claim 8, further comprising:
identifying a request for a second OTA update for a fleet of the vehicles;
identifying a second software state of the ECUs in the vehicles of the fleet;
selecting a second set of the updated software components for installation in the vehicles of the fleet based on the second software state and a second one of the authorized software configurations for the vehicles of the fleet;
generating a second update plan for installing the second set of the updated software components based on the second software state and the second one of the authorized software configurations, wherein the second update plan indicates an order for installing the second set of the updated software components in the vehicles of the fleet; and
pushing the second update plan to the vehicles of the fleet via OTA connections.

14. The method of claim 8, further comprising:
providing a user interface that allows a supplier to upload the updated software components.

15. A non-transitory computer readable medium embodying programmed instructions executed by one or more processors, wherein the instructions direct the processors to implement a method of performing Over-The-Air (OTA) updates for vehicles at an OTA update manager, the method comprising:
storing updated software components for Electronic Control Units (ECUs) installed in the vehicles;
storing authorized software configurations for the vehicles that are verified by a manufacturer;
establishing an OTA connection with a first one of the vehicles for a first OTA update; and
responsive to the first one of the vehicles connecting with the OTA update manager:
identifying a first software state of the ECUs in the first one of the vehicles;
selecting a first set of the updated software components for installation in the first one of the vehicles based on the first software state and a first one of the authorized software configurations for the first one of the vehicles;
generating a first update plan for installing the first set of the updated software components based on the first software state and the first one of the authorized software configurations, wherein the first update plan indicates an order for installing the first set of the updated software components in the first one of the vehicles; and
downloading the first update plan to the first one of the vehicles via the OTA connection for the first OTA update.

16. The computer readable medium of claim 15, wherein the method further comprises:
downloading the first set of the updated software components to the first one of the vehicles via the OTA connection for the first OTA update along with the first update plan as part of an update package.

17. The computer readable medium of claim 15, wherein the method further comprises:
downloading each updated software component of the first set separately over the OTA connection in response to a request from the first one of the vehicles.

18. The computer readable medium of claim 15, wherein establishing the OTA connection comprises:
establishing the OTA connection over a cellular network.

19. The computer readable medium of claim 15, wherein establishing the OTA connection comprises:
establishing the OTA connection over a Wireless Local Area Network (WLAN).

20. The computer readable medium of claim 15, wherein the method further comprises:
identifying a request for a second OTA update for a fleet of the vehicles;
identifying a second software state of the ECUs in the vehicles of the fleet;
selecting a second set of the updated software components for installation in the vehicles of the fleet based on the second software state and a second one of the authorized software configurations for the vehicles of the fleet;
generating a second update plan for installing the second set of the updated software components based on the second software state and the second one of the authorized software configurations, wherein the second update plan indicates an order for installing the second set of the updated software components in the vehicles of the fleet; and
pushing the second update plan to the vehicles of the fleet via OTA connections.
